(19) United States
(12) Patent Application Publication
(10) Pub. No.: US 2015/0025957 A1
(43) Pub. Date: Jan. 22, 2015

(54) METHOD AND APPARATUS FOR TESTING IN-PRODUCT MARKETING CONTENT

(71) Applicant: Adobe Systems Incorporated, San Jose, CA (US)

(72) Inventors: Lalit Vohra, New Delhi (IN); Abhishek Modi, Jhunjhunu (IN); Rajeev Sharma, Noida (IN); Randy Lee Swineford, Sunnyvale, CA (US)

(73) Assignee: Adobe Systems Incorporated, San Jose, CA (US)

(21) Appl. No.: 13/946,255

(22) Filed: Jul. 19, 2013

(51) Int. Cl. G06Q 30/02

(52) U.S. Cl. CPC G06Q 30/0242
USPC 705/14.41

(57) ABSTRACT

A computer implemented method and apparatus for testing in-product marketing content. The method comprise defining a plurality of populations for a user base of a software application using a plurality of population identifiers, wherein a population identifier of the plurality of population identifiers is generated by the software application and identifies a population of the plurality of populations; associating at least one in-product message with each defined population in the plurality of populations; and supplying the in-product messages to the software application having a population identifier within a range of population identifiers that define the population.

### BACKGROUND OF THE INVENTION

1. Field of the Invention

Embodiments of the present invention generally relate to marketing and, more particularly, to a method and apparatus for testing in-product marketing content.

2. Description of the Related Art

Advertising research is a specialized form of marketing research conducted to improve the efficiency of advertising. Advertising testing allows marketers to test the effectiveness of their marketing content and its display. With the ubiquity of software applications, such as ADOBE® READER® or ACROBAT®, advertising within these software applications is a key marketing opportunity. In-Product Messaging (IPM) involves creating IPM messages and pushing the IPM messages to client machines running software applications that subsequently display the IPM messages in the software applications according to conditions under which the IPM message should be displayed. Before launching an advertising campaign, marketers would like to test the effectiveness of their marketing content and its display within these software applications. However, effective solutions are not available for determining such effectiveness.

Therefore, there is a need for a method and apparatus for testing in-product marketing content.

### SUMMARY OF THE INVENTION

A method and apparatus for testing in-product marketing content substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram of a system for testing in-product marketing content, according to one or more embodiments;

FIG. 2 depicts a flow diagram of a method for administering in-product marketing content as performed by the IPM administration tool of FIG. 1, according to one or more embodiments; and

FIG. 3 depicts a flow diagram of a method for processing in-product marketing content as performed by the IPM client of FIG. 1, according to one or more embodiments.

While the method and apparatus is described herein by way of example for several embodiments and illustrative drawings, those skilled in the art will recognize that the method and apparatus for testing in-product marketing content is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for testing in-product marketing content defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of the present invention include a method and apparatus for testing in-product marketing content. The embodiments provide a tool for creating and editing In-Product Messaging (IPM) messages. The end-user client base of a software application is divided into populations wherein each population is a distinct subset of end-users, or more specifically, of the end-user computing devices that are running the software application. For example, ADOBE READER has an end-user client base of roughly one billion users. For testing purposes, the end-user base is filtered based on a plurality of defined constraints, such as locale, original equipment manufacturer (OEM), operating system (OS), software application, product version, product license, and the like. For example, the end-user base of ADOBE READER may be filtered to create a filtered user base of English speaking users of ADOBE READER version 11.0 that runs on a WINDOWS operating system. From the filtered user base, one or more test populations are created. Within each test population, subsets, or segments of the population may also be created. A marketer targets IPM messages to specific populations and if desired, segments of those specific populations. The IPM messages and the populations and segments to which they are assigned are stored in an XML file.

When the software application, for example, ADOBE READER, is first launched on a client device, the software application assigns itself a populationID and a segmentID. In some embodiments, a random number between 1 and 100 is assigned as the populationID and another random number between 1 and 100 is assigned as the segmentID. The random number is generated using any random number generator, for example, MD5, that is capable of generating a random number between a range of numbers. The software application then downloads all IPM messages based on its fixed constraints (locale, OEM, OS, software application, version, etc.) The software application then filters the IPM messages based on its specific populationID and segmentID and stores the filtered IPM messages. The software application displays filtered IPM messages according to control information provided with each IPM message. The control information describes the various semantics and conditions under which an IPM message is displayed to an end user within the application. The control information may include a title, message content, an icon, an accept label, a reject label, a start date, an expiry date, and/or a priority. The IPM message may also include a location where to display the IPM message, and an external link, which defines the action that takes place upon clicking on the IPM message. The control information also describes a range of populationID and segmentID. In some embodiments, if no populationID and segmentID range are provided, as a default, the IPM is to target all end-users that meet the fixed constraints. The software application gathers analytics regarding the end-user's interactions with the IPM messages. The analytics are provided to the marketer (or creator) of the IPM messages, who may then edit the IPM messages, redistribute the test populations, target new messages to the redistributed test populations, and the like.

Advantageously, embodiments of the present invention provide a marketer of a software application, such as ADOBE® READER® with a powerful tool that can test marketing content using one or more select populations of clients to determine the effectiveness of the marketing content. Using the client assigned populationID and segmentID, the marketer may easily redistribute populations and segments to fine tune testing of IPM messages. By simply changing a number range of populationIDs and segmentIDs that are to receive a given IPM message, the marketer can redefine a test population. Further by associating IPM messages to a range of populationIDs and segmentIDs, populations may be easily divided or merged with other populations in whole or in part while ensuring no other users outside of the test populations are impacted.

Various embodiments of a method and apparatus for testing in-product marketing content are described. In the following detailed description, numerous specific details are set forth to provide a thorough understanding of the claimed subject matter. However, it will be understood by those skilled in the art that the claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

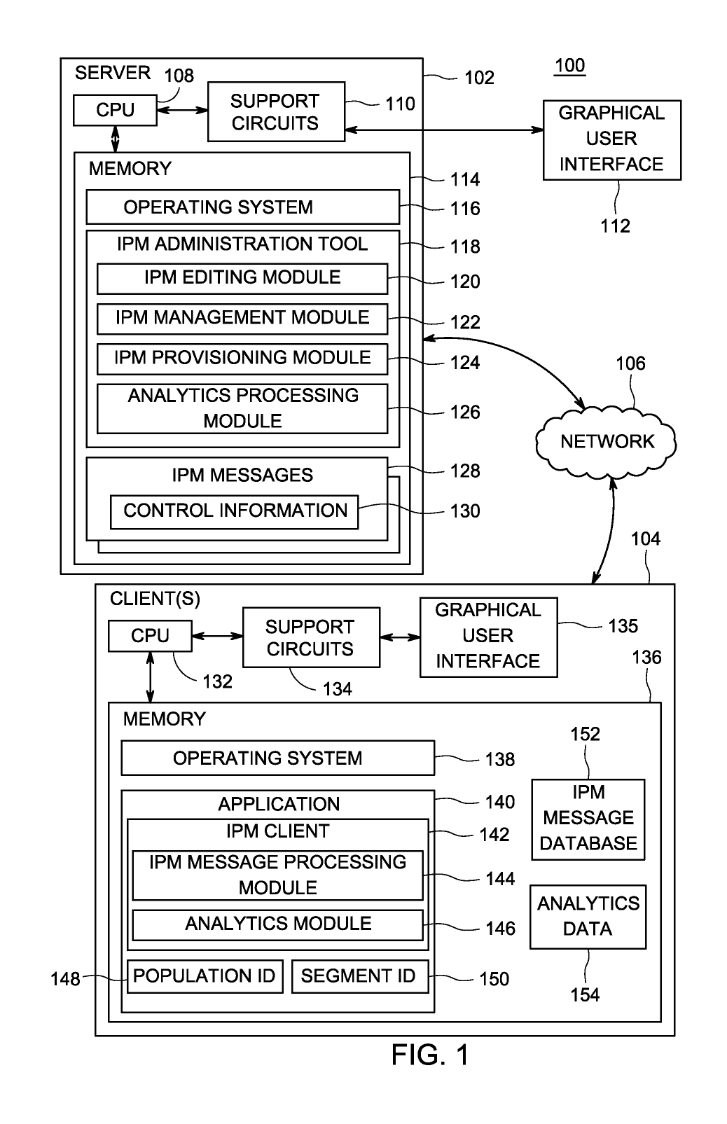

FIG. 1 is a block diagram of a system 100 for testing in-product marketing content, according to one or more embodiments. The system 100 includes a server 102, and a plurality of clients 104, communicatively coupled to one another via a network 106. The server 102 is a type of computing device known to one of ordinary skill in the art that is used for providing computing services within the cloud, e.g., a blade server, virtual machine, and the like that includes or is attached to a graphical user interface 112. The server 102 may be a marketing server and includes a Central Processing Unit (CPU) 108, support circuits 110, and a memory 114. The CPU 108 may include one or more commercially available microprocessors or microcontrollers that facilitate data processing and storage. The various support circuits 110 facilitate the operation of the CPU 108 and include one or more clock circuits, power supplies, cache, input/output circuits, and the like. The memory 114 includes at least one of Read Only Memory (ROM), Random Access Memory (RAM), disk drive storage, optical storage, removable storage and/or the like.

The memory 114 includes an operating system 116, an IPM administration tool 118, and a plurality of IPM messages 128. In some embodiments, the plurality of IPM messages 128 are stored remotely from the server 102. The IPM administration tool 118 includes an IPM editing module 120, an IPM management module 122, and IPM provisioning module 124, and an analytics processing module 126. The IPM messages 128 include control information 130. The control information 130 may include, but is not limited to, a title, message content, an icon, an accept label, a reject label, a start date, an expiry date, and/or a priority. The control information 130 may also include a location where the IPM message 128 is to be displayed inside the application 140, and an external link, which defines the action that takes place upon user interaction with the IPM message 128. The operating system 116 may include various commercially known operating systems.

The network 106 includes a communication system that connects computers (or devices) by wire, cable, fiber optic and/or wireless link facilitated by various types of well-known network elements, such as hubs, switches, routers, and the like. The network 106 may be a part of the Intranet using various communications infrastructure, such as Ethernet, Wi-Fi, a personal area network (PAN), a wireless PAN, Bluetooth, Near field communication, and the like.

The client 104 is a computing device, such as a desktop computer, laptop, tablet computer, and the like, operable by an end user. The client 104 includes a Central Processing Unit (CPU) 132, support circuits 134, a graphical user interface 135, and a memory 136. The CPU 132 may include one or more commercially available microprocessors or microcontrollers that facilitate data processing and storage. The various support circuits 134 facilitate the operation of the CPU 132 and include one or more clock circuits, power supplies, cache, input/output circuits, and the like. The memory 136 includes at least one of Read Only Memory (ROM), Random Access Memory (RAM), disk drive storage, optical storage, removable storage and/or the like.

The memory 136 includes an operating system 138, an application 140, an IPM message database 152 and analytics data 154. The operating system 138 may include various commercially known operating systems. The application 140 may be any desktop or mobile software application, such as ADOBE® ACROBAT®, ADOBE® READER®, and the like, capable of interacting with an end-user of client 104. It is noted that in some embodiments, portions of client 104 may be implemented as a virtual machine without departing from the invention. The application 140 includes an IPM client 142 comprising an IPM message processing module 144 and an analytics module 146, and has a populationID 148, and a segmentID 150 created by the IPM client 142. The IPM message processing module 144 and analytics module 146 are configured to provide additional functionalities to the application 140 via, e.g., an add-on, plug-in, or extension. The population ID 148 and segmentID 150 of the application 140 are created by the IPM client 142 the first time the application 140 having an IPM client 142 is launched. The IPM client 142 generates a random number within a predetermined range, for example 1-100 and stores the number as the populationID 148. In some embodiments, the IPM client 142 repeats the process and stores a second random number within the predetermined range as the segmentID 150. The random number is generated using any random number generator, for example, MD5, that is capable of generating a random number between a range of numbers. The IPM message database 152 provides storage for the IPM messages 128 received from the server 102. The plurality of clients 104 represent the end-user base of the application 140. The plurality of clients 104 is filtered by the marketer based on a plurality of constraints, such as locale, original equipment manufacturer (OEM), operating system (OS), software application, product version, product license, and the like. The plurality of clients 104 is further grouped so as to define IPM message distribution to end-users based on a given population within the plurality of clients 104 and in some embodiments a given segment within that given population. Thus, the plurality of clients 104 are logically grouped on the basis of a given scheme, each group consisting of a subset of the entire user base of end-users of the application 140. One client 104 (end-user) can be a part of only one logical group at any time.

Thus, in some embodiments, the plurality of clients 104 may be initially divided by the marketer into subsets of end-users based on a plurality of constraints, such as locale, original equipment manufacturer (OEM), operating system (OS), software application, product version, product license, and the like. In other embodiments, the population may be divided based on alternate criteria, such as users of multiple software applications or product licenses. After the initial grouping of the plurality of clients 104, a marketer may use the IPM management module 122 to define one or more segments of each population via the graphical user interface 112. For example, ADOBE READER has an end-user base of roughly 1 billion end-users. Within this group of end-users, a marketer may wish to test IPMs message 128 to a population of English-speaking users in the United States who are running ADOBE READER 11.0 on a WINDOWS platform. The plurality of clients 104 that meet the criteria of the marketer are hereafter referred to as a filtered user base. The marketer may assign one or more IPM messages 128 to be tested by a subset of the filtered user base, hereafter referred to as a test population.

There may be one or more test populations and a general population. Furthermore, as noted above, the one or more test populations may be further divided into one or more subsets, or segments of the test population. For example, a marketer may define testPopulationA that represents 10% of the filtered user base (e.g., clients 104 that have a populationID 148 within the range 1-10). The marketer may also define testPopulationB that represents a different 10% of the filtered user base (e.g., clients 104 that have a populationID 148 within the range 11-20), and a generalPopulation that represents the remaining 80% of the filtered user base (e.g., clients 104 that have a populationID 148 within the range 21-100). A marketer may assign one or more IPM messages 128 related to ADOBE ACROBAT Document Services to be tested on testPopulationA and may assign one or more IPM messages 128 related to ExportPDF to be tested on testPopulationB. However, it may be that the marketer may want to test two different versions of IPM messages 128 related to ExportPDF. In that case, in accordance with an embodiment of the invention the marketer may divide testPopulationB into two segments, namely testSegment1 and testSegment2. The marketer may assign one set of IPM messages 128 related to ExportPDF to testSegment1 within testPopulationB (e.g., clients 104 with PopulationID 148 within the range 11-20 and segmentID 150 within the range 1-50) and the different version of IPM messages 128 related to ExportPDF to testSegment2 of testPopulationB (e.g., clients 104 with PopulationID 148 within the range 11-20 and segmentID 150 within the range 51-100). The IPM management module 122 may be used to define any number of test populations and segments of populations within the defined number of populations, as needed by the marketer.

The IPM editing module 120 enables creation, editing and storing of IPM messages 128. The IPM editing module 120 also enables creating control information 130 as part of each IPM message 128, wherein the control information 130 defines conditions under which the IPM message 128 is displayed. The IPM provisioning module 124 enables associating populations and segments of populations to a plurality of IPM messages 128.

The IPM message processing module 144 downloads IPM messages 128 that are associated with the operating system 138, application 140, and other device information associated with the client 104. In some embodiments, the IPM message processing module 144 downloads the IPM messages 128 at predefined intervals, for example, weekly. In other embodiments, the IPM messages 128 are downloaded when the application 140 executes. In addition, the IPM provisioning module 124 may send IPM messages 128 to the client 104 at will. The IPM message processing module 144 filters the downloaded IPM messages 128 based on the population and segment of the client 104 and stores the filtered IPM messages 128 in the IPM message database 148. Thereafter, all IPM messages 128 for the filtered user base are available at the client 104 for display in software application 140 in accordance with the control information 130. More specifically, for all clients 104 who meet the fixed base level of constraints, and who also have a populationID and segmentID that falls within the range of populationID and segmentID specified by the IPM message 128, the IPM messages 128 are available for display in software application 140 in accordance with the control information 130. Because the IPM messages 128 include a range of populationID and segmentID, by adjusting the range of populationID and segmentID in the IPM messages 128, great flexibility in specifying message distribution becomes possible, such as targeting test messages 128 only to clients 104 having a given populationID and segmentID and providing general or default messages 128 to clients 104 having any populationID and segmentID that is not within a test population range (i.e., all other clients 104).

The IPM message processing module 144 displays the IPM messages inside the application 140 according to the control information 130 included with the IPM messages. The analytics module 146 monitors and stores an end-user's interactions with the IPM messages inside the application 140 via the graphical user interface 135, and sends the analytics data 154 to the server 102. The analytics data 154 includes the populationID 148 and segmentID 150 associated with the interaction. In some embodiments, the analytics data 154 is sent to a third party analytics server for processing before the analytics data 154 is sent to the server 102. In some embodiments, the analytics module 146 sends the analytics data 154 to the server 102 at predefined intervals. In other embodiments, the analytics module 146 sends the analytics data 154 to the server 102 as the analytics data 154 is collected.

The analytics processing module 126 receives the analytics data 154 and provides reports regarding the success or failure of the IPM messages based on end-user interaction with the IPM messages. A marketer may then use the IPM editing module 120 to edit or create new IPM messages 128, based on the received analytics data 154. The marketer may also use the IPM management module 122 to redistribute or further divide the populations and segments based on the analytics data 154. The process iterates until the marketer's IPM message testing is complete.

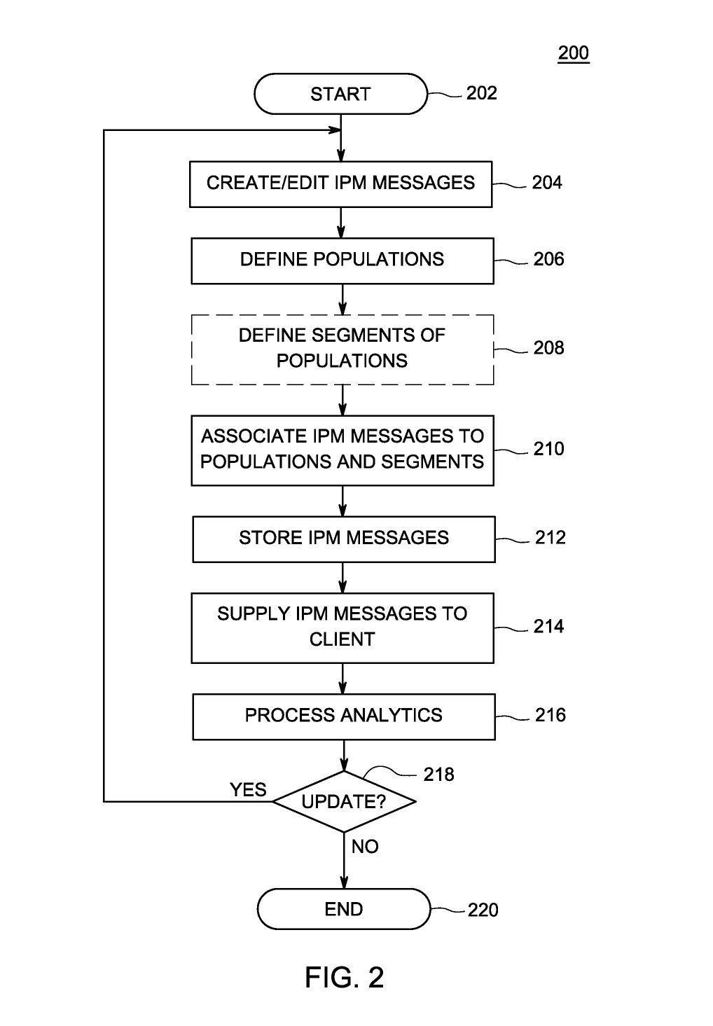

FIG. 2 depicts a flow diagram of a method 200 for administering in-product marketing content as performed by IPM administration tool 118 of FIG. 1, according to one or more embodiments. The method 200 creates IPM messages, defines populations, associates populations with IPM messages, and receives analytics regarding an end-user's interactions with the IPM messages. The method 200 starts at step 202 and proceeds to step 204.

At step 204, the method 200 creates IPM messages. The IPM messages may be created via a graphical user interface. The IPM messages may be a set of IPM messages that are displayed inside of a software application at predefined locations. The messages may include any information that a marketer deems valuable. In a non-limiting example, the messages may include a message title, message content, a display location, a display context, an image, and the like. For example, the message may be entitled “ADOBE ExportPDF”. The message content may be “Convert PDF files to WORD or EXCEL online”. The display location is the location inside the software application where the message is displayed, for example, “Gateway”, “SharePane”, or “Toolbar”. The display context refers to the context within the location in which the message is displayed, for example, “FirstUse”, “SecondUse”, “SignUp”, and the like. In addition, a correlation may be identified for a set of messages, for example, “If messageA is displayed at the Gateway, then display messageB at the SharePane.” The image may be any icon that represents the information included in the message. The messages may also include a start date and an expiry date for when the message is to be displayed. The message may include an external link, which when selected, performs an action. The action may include navigating to a document, web page, or the like for further information, or opening a specific IPM message in a specific location. For example, clicking on an IPM message on the Gateway may have an associated action of opening an ExportPDF panel under a Tools pane.

The method 200 proceeds to step 206, where the method 200 defines one or more test populations and a general population. A test population is typically a small percentage of total users who receive IPM messages that are being tested. The end-users who are not part of a test population are referred to as the general population, and receive IPM messages that are not being tested. The number of test populations may be based on a number of sets of IPM messages that are being tested. For example, if each end-user of a population is randomly assigned a populationID from 1-100, and a marketer wants a first message tested on 10% of the population, a second message tested on another 10% of the population and a third message tested on 5% of the population, a first population (P1) may be defined as end-users who are assigned numbers 1-10. A second population (P2) may be defined as end-users who are assigned numbers 11-20, and a third population (P3) may be defined as end-users who are assigned numbers 21-25. Any end-user who does not have an assigned number between 1 and 25 is part of the general population.

Table 1 below, shows the breakdown of populations.

TABLE 1

| Population | Start Range | End Range |
|---|---|---|
| P1 | 1 | 10 |
| P2 | 11 | 20 |
| P3 | 21 | 25 |

The method 200 optionally proceeds to step 208, where one or more populations may be subdivided into smaller segments of the population. Within each population, segments of the population may be defined. For example, a marketer may want a first version of IPM messages related to ExportPDF tested on a first half of P2 and a second version of IPM messages related to ExportPDF tested on the second half of P2. Each end user is randomly assigned a segmentID, for example based on a randomly assigned number between 1-100. The marketer may assign segments as follows using the randomly assigned segmentID

TABLE 2

| Segment | Start Range | End Range |
|---|---|---|
| S1 | 1 | 50 |
| S2 | 51 | 100 |

The method 200 proceeds to step 210, where the method 200 associates the created (or edited) IPM messages with populations and segments. The method 200 adds a populationID and segmentID to the IPM message. The populationID and segmentID identify a specific population and segment of end-users to whom the message is directed.

The method 200 proceeds to step 212, where the method 200 stores the IPM messages. The method 200 proceeds to step 214, where the method 200 supplies the IPM messages to a plurality of client computing devices. In some embodiments, all IPM messages are sent to all client computing devices that meet criteria, for example, the client computing devices with the operating system, application, and other device information for which the IPM messages are intended. In some embodiments, only IPM messages that are created for the population and segment in which the client computing device is included are supplied to the client computing device.

The method 200 proceeds to step 216, where the method 200 processes analytics data that includes information regarding an end-user's interactions with the IPM messages. The analytics data can be used to determine the success or failure of an IPM message. For example, if a large percentage of end-users dismissed or otherwise rejected an IPM message, the method 200 may identify that as a failure. As an end-user interacts with an IPM message, the method 200 facilitates sending the interaction to an analytics server.

The method 200 proceeds to step 218, where the method 200 determines whether the analytics data implies the need for more testing. If the method 200 determines that more testing is needed, the method 200 proceeds to step 204. The method 200 iterates allowing modifications to the IPM messages and redistribution of the populations until testing is complete, at which point the method 200 proceeds to step 220 and ends. However, if at step 218, the method 200 determines that no further testing is required, the method 200 proceeds directly to step 220 and ends.

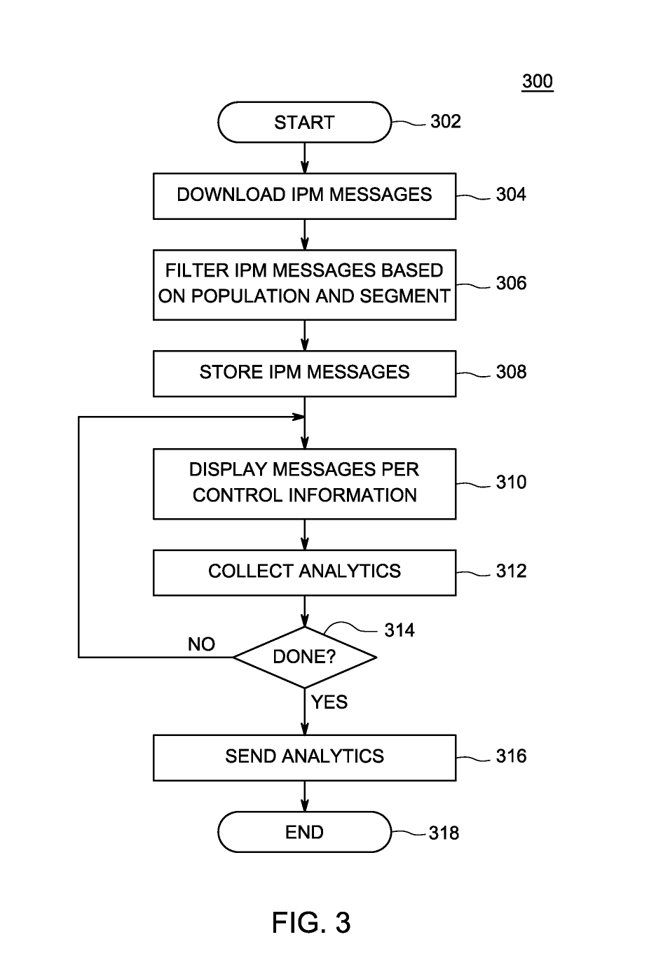

FIG. 3 depicts a flow diagram of a method 300 for processing in-product marketing content as performed by the IPM client 142 of FIG. 1, according to one or more embodiments. When a software application, for example, ADOBE READER launches for the first time, it generates two random numbers within a predefined range. The random numbers are generated using any random number generator known in the art that is capable of generating a number within a given range, for example, 1-100. One random number is stored as the client's populationID and the other is stored as the client's segmentID. The populationID and segmentID are used by the method 300. The method 300 receives IPM messages, filters the messages based on the clients' defined populationID and segmentID, and displays the messages in the software application according to control information included with the message. The method 300 also records analytics data regarding user interactions with the messages and sends the analytics data to a server for review by marketers. The method 300 starts at step 302 and proceeds to step 304.

At step 304, the method 300 downloads a plurality of IPM messages from a server. In some embodiments, only those IPM messages directed toward a client based on a plurality of constraints, such as locale, original equipment manufacturer (OEM), operating system (OS), software application, product version, product license, and the like are downloaded. In some embodiments, only those IPM messages associated with the specific population of the client are downloaded.

The method 300 proceeds to step 306, where the method 300 filters the IPM messages according to the clients' populationID and segmentID. A client assigns itself a random number from a predefined interval, for example 1-100 and stores the random number as its populationID. The client repeats the process and stores a second random number as its segmentID. The assigned random number is generated using any random number generator, for example, MD5, that is capable of generating a random number between a range of numbers. The populations are defined as a range of these random numbers. For example, a test population may be defined as populationName=EPDF, which includes all clients with a populationID within the range 1-5. If, for example, the client has a populationID of 4, then the client is within the range 1-5 and is part of the population EPDF. Further, the population EPDF may be divided into segments. For example, population EPDF may have two segments, wherein segmentA may be defined as all members of population EPDF with a segmentID of 1-30 and segmentB may be defined as all members of population EPDF with segmentID of 31-100. The method 300 filters the IPM messages and extracts only those IPM messages for populationName EPDF, and if applicable, those IPM messages for the clients' specific segment. The method 300 proceeds to step 308, where the method 300 stores the filtered IPM messages.

The method 300 proceeds to step 310 where the method 300 displays each IPM message according to control information included in the IPM message. For example, an IPM message may include a title, message content, and a display location. When a user of the software application navigates to the display location identified in the IPM message control information, the method 300 displays the message including the title, message content, and any other information included in the IPM message, such as an image, an external link, and the like. If a context is included in the control information, for example, “FirstUseIPM”, meaning only display the message the first time the IPM messages are displayed, then the message is displayed in accordance with the context. A start/expiry date may be included in the control information. The IPM message is displayed during the duration from the start date to the expiry date. If the expiry date has passed, the method 300 may display a generic, non-test message or the method 300 may display no message at all. The IPM message includes an item with which a user may interact with the IPM message. For example, a question may be displayed, such as “Would you like more information?” with an area for the user to respond with an affirmative response or a negative response.

The method 300 proceeds to step 312, where the method 300 collects analytics data for the IPM message. Whether the user responds affirmatively or negatively to the IPM message, or whether the user selects the external link or ignores the IPM message, the interaction is stored as analytics data along with the user's populationID, segmentID, if applicable, and an identifier to identify the IPM message. The method 300 proceeds to step 314, where the method 300 determines whether the user is done using the software application. The method 300 may determine the user is done when the software application is closed, when the software application is idle for a predefined period of time, or other any other means to determine that no further analytics are to be collected. If the method 300 determines that the user is not done, the method 300 proceeds to step 310, where the method 300 iterates until at step 314, the method 300 determines that the user is done at which time the method 300 proceeds to step 316.

At step 316, the method 300 facilitates sending the analytics data to a server. In some embodiments, the analytics data is sent to the server as the data is collected. In some embodiments, the analytics data is collected and sent when there is an indication that the end-user is finished using the software application. In some embodiments, the server is the marketing server. In some embodiments, the server is an analytics server that processes the data before it is sent to the marketing server.

Hence, test messages may be targeted to a specific subset of end-users (i.e., test population) of a given software application, wherein the end-user base has the same configuration as the test population. One or more test populations may be modified or redistributed and the IPM messages may be modified and retargeted based on past IPM testing on the targeted test population. This provides a very effective testing strategy for marketers. The method 300 proceeds to step 318 and ends.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java™, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. For example, in some embodiments, only populationID's are used for creating test populations, and a segmentID may be neither assigned by the software application nor used by the marketer. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method comprising:
defining a plurality of populations for a user base of a software application using a plurality of population identifiers, wherein a population identifier of the plurality of population identifiers is generated by the software application and identifies a population of the plurality of populations;
associating at least one in-product message with each defined population in the plurality of populations; and
supplying the in-product messages to the software application having a population identifier within a range of population identifiers that define the population.

2. The method of claim 1, further comprising:
receiving analytics regarding interactions of the end-users with the supplied in-product messages.

3. The method of claim 2, further comprising:
redefining the plurality of populations; and
associating a plurality of edited in-product messages with each redefined population.

4. The method of claim 2, wherein receiving the analytics comprises receiving at least a population identifier and an in-product message identifier.

5. The method of claim 1, wherein the user base is based at least on a locale, an operating system, the software application, and a version of the software application.

6. The method of claim 1, wherein the defined population is divided into at least one test population and a general population, wherein the at least one test population represents a predefined percentage of a defined population.

7. The method of claim 1, wherein each in-product message comprises control information, wherein the control information comprises at least message content, a display location, and the population identifier.

8. The method of claim 6, wherein a test population is further divided into a plurality of segments, each segment defined by a segment identifier, wherein the software application generates the segment identifier randomly.

9. A computer implemented method comprising:
generating, by a software application, a population identifier related to the software application;
receiving a plurality of in-product messages, wherein the in-product messages are defined to be displayed inside of the software application having a defined population comprising the population identifier;
filtering the plurality of in-product messages based on the population identifier being within a test population within the defined population; and
displaying the filtered in-product messages inside of the software application based on the population identifier being within the test population.

10. The method of claim 9, further comprising:
collecting analytics data regarding an end-user's interaction with the in-product messages; and
sending the analytics data to a server for analysis.

11. The method of claim 9, wherein each in-product message is defined to be displayed only to end-users of the software application having a population identifier within the test population.

12. The method of claim 9, wherein each in-product message of the plurality of in-product messages comprises control information, wherein control information comprises at least message content, a display location, and a range of population identifiers.

13. The method of claim 9, wherein a test population is further divided into a plurality of segments, each segment defined by a segment identifier, wherein the software application generates the segment identifier randomly.

14. The method of claim 9, wherein displaying comprises displaying an in-product message based on the control information.

15. An apparatus for testing in-product marketing content comprising:
a computer having one or more processors and further comprising:
an in-product message client for receiving a plurality of in-product messages, wherein the in-product messages are defined to be displayed inside of a software application; generating a population identifier related to the software application; determine a population based on the population identifier, filtering the plurality of in-product messages based on the determined population; and displaying the filtered in-product messages inside of the software application.

16. The apparatus of claim 15, wherein the in-product message client further collects analytics data regarding a end-user's interaction with the in-product messages, and sends the analytics data to a server for analysis.

17. The apparatus of claim 15, wherein the in-product client:
downloads a plurality of IPM messages;
determines a population based on the population identifier and a segment identifier generated by the software application, wherein the population is defined as a range of population identifiers and a range of segment identifiers;
filters the IPM messages based on the determined population;
stores the filtered IPM messages; and
displays the IPM messages according to control information.

18. The apparatus of claim 15, wherein each in-product message is defined to be displayed only to end-users of the software application having a population identifier within one of the plurality of defined populations.

19. The apparatus of claim 15, wherein each in-product message of the plurality of in-product messages comprises control information, and wherein the control information comprises at least message content, a display location, and the population identifier.

20. The apparatus of claim 15, wherein displaying comprises displaying an in-product message based on the control information.
